(19) United States
(12) Patent Application Publication
(10) Pub. No.: US 2015/0154101 A1
(43) Pub. Date: Jun. 4, 2015

(54) TUNING BUSINESS SOFTWARE FOR A SPECIFIC BUSINESS ENVIRONMENT

(71) Applicant: International Business Machines Corporation, Armonk, NY (US)

(72) Inventor: Alexander N. Perira, Bangalore (IN)

(21) Appl. No.: 14/307,692

(22) Filed: Jun. 18, 2014

Related U.S. Application Data
(63) Continuation of application No. 14/096,228, filed on Dec. 4, 2013.

(51) Int. Cl. G06F 11/36

(52) U.S. Cl. CPC G06F 11/3644

(57) ABSTRACT

Tuning business software for a specific business environment includes: setting up an instrumented version of a first software image to run in a deployment environment, generating profile data by running the instrumented version of the first software image in the deployment environment to perform actual business operations, and performing binary profiling on the first software image, based, at least in part, upon the profile data, to create a second software image that is fine tuned for the deployment environment.

### FIELD OF THE INVENTION

The present invention relates generally to the field of software program development tools, and more particularly to testing and/or debugging including instrumentation and profiling.

### BACKGROUND OF THE INVENTION

A generic software solution (also herein referred to as a “generic software image” and “generic software product”) typically exhibits performance fluctuation from one deployment environment to another. (See definition of “deployment environment,” below, in the Definitions sub-section of the Detailed Description section of this document.) For example, a database product will not perform consistently from one customer's networked computers environment (a deployment environment) to that of another customer. As a result of this, it is conventional to make slight revisions to the generic software solution by revising the “software image” (that is, the machine-readable instructions and/or application software itself). This is known as “profiling” the software image. However, the conventional practice of profiling the software image is deployment environment specific in the sense that a software image that has been profiled for a first deployment environment will generally not work (or work well) in a second deployment environment.

This remains true for any software code written for OS, Message Queues, JVMs, Transactions Managers, and/or any application designed for hosting and/or hosting environment. Occasionally, one portion of a given software stack may perform better than usual, but the improved performance is nullified by another portion in the same stack that is performing poorly. Performance degradation in generic software is often expected to occur as a matter of course.

Conventionally, software is profiled for a given deployment environment through the following steps: (i) collecting information about common software customer's business environment where common generic software application (or previous iteration of a software image, generically herein called the base software image) is to be used; (ii) setting up a “simulation” of the business environment at the software developer's location (a non-deployment environment); and (iii) running the base software in the simulation business environment (a non-deployment environment) while collecting information about how the base software performs in the simulation business environment; (iv) using the collected information regarding performance of the base software, collected at the software developer's location, to revise the base image of the software and create a target software image which is better optimized for use in the simulation business environment (and, by “proxy” in the customer's actual business environment); and (v) running the target software image in the customer's business environment to perform business tasks.

### SUMMARY

According to one aspect of the present disclosure, there is a computer program product, system and/or method which performs the following actions (not necessarily in the following order and not necessarily in serial sequence): setting up an instrumented version of a first software image to run in a deployment environment, generating profile data by running the instrumented version of the first software image in the deployment environment to perform actual business operations, and performing binary profiling on the first software image, based, at least in part, upon the profile data, to create a second software image that is fine tuned for the deployment environment.

### BRIEF DESCRIPTION OF THE SEVERAL VIEWS OF THE DRAWINGS

FIG. 1 is a schematic view of a first embodiment of a networked computers system according to the present invention;

FIG. 2 is a flowchart showing a process performed, at least in part, by the first embodiment computer system;

FIG. 3 is a schematic view of a portion of the first embodiment system; and

FIG. 4 is a flowchart showing a process according to the present invention.

### DETAILED DESCRIPTION

This Detailed Description section is divided into the following sub-sections: (i) The Hardware and Software Environment; (ii) First Embodiment; (iii) Further Comments and/or Embodiments; and (iv) Definitions.

### I. The Hardware and Software Environment

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer-readable program code/instructions embodied thereon.

Any combination of computer-readable media may be utilized. Computer-readable media may be a computer-readable signal medium or a computer-readable storage medium. A computer-readable storage medium may be, for example, but not limited to, an electronic, a magnetic, an optical, an electromagnetic, an infrared, or a semiconductor system, apparatus, or device, or any suitable combination of the foregoing. More specific examples (a non-exhaustive list) of a computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object-oriented programming language such as Java (note: the term(s) “Java” may be subject to trademark rights in various jurisdictions throughout the world and are used here only in reference to the products or services properly denominated by the marks to the extent that such trademark rights may exist), Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

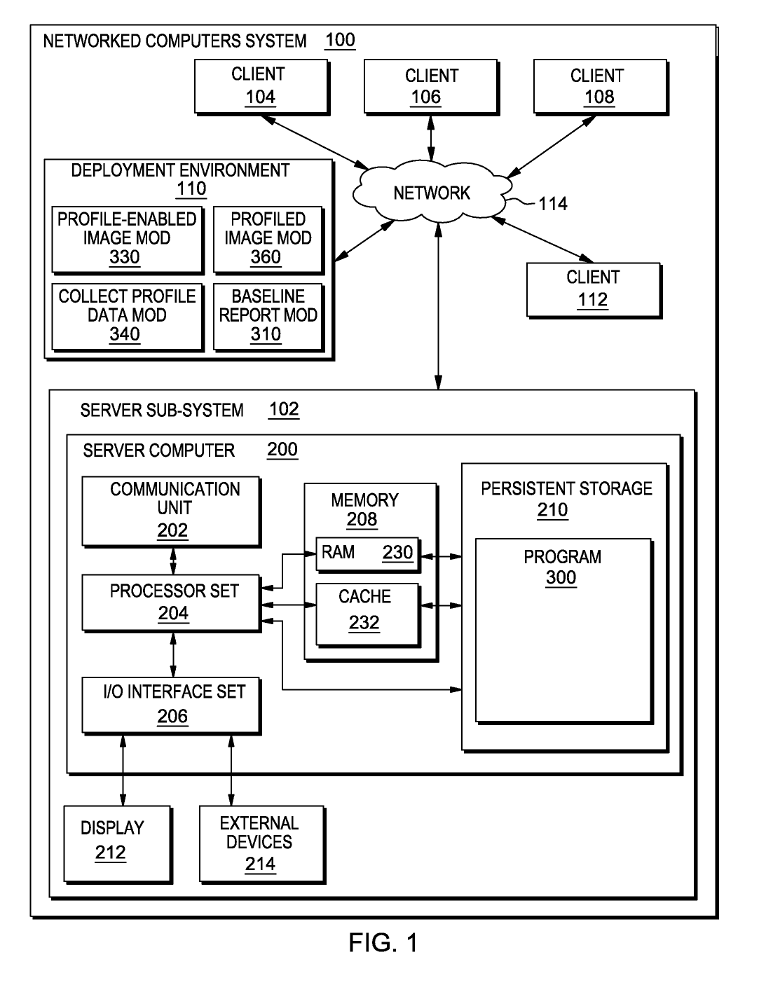

An embodiment of a possible hardware and software environment for software and/or methods according to the present invention will now be described in detail with reference to the Figures. FIG. 1 is a functional block diagram illustrating various portions of networked computers system 100, including: server computer sub-system 102; client computer sub-systems 104, 106, 108, 112; deployment environment 110; communication network 114; server computer 200; communication unit 202; processor set 204; input/output (i/o) interface set 206; memory device 208; persistent storage device 210; display device 212; external device set 214; random access memory (RAM) devices 230; cache memory device 232; and program 300.

Server computer sub-system 102 is, in many respects, representative of the various computer sub-system(s) in the present invention. Accordingly, several portions of computer sub-system 102 will now be discussed in the following paragraphs.

Server computer sub-system 102 may be a laptop computer, a tablet computer, a netbook computer, a personal computer (PC), a desktop computer, a personal digital assistant (PDA), a smart phone, or any programmable electronic device capable of communicating with the client sub-systems via network 114. Program 300 is a collection of machine-readable instructions and/or data that is used to create, manage and control certain software functions that will be discussed in detail, below, in the First Embodiment sub-section of this Detailed Description section.

Server computer sub-system 102 is capable of communicating with other computer sub-systems via network 114. Network 114 can be, for example, a local area network (LAN), a wide area network (WAN), such as the Internet, or a combination of the two, and can include wired, wireless, or fiber optic connections. In general, network 114 can be any combination of connections and protocols that will support communications between server and client sub-systems.

It should be appreciated that FIG. 1 provides only an illustration of one implementation (that is, system 100) and does not imply any limitations with regard to the environments in which different embodiments may be implemented. Many modifications to the depicted environment may be made, especially with respect to current and anticipated future advances in cloud computing, distributed computing, smaller computing devices, network communications and the like.

Server computer sub-system 102 is shown as a block diagram with many double arrows. These double arrows (no separate reference numerals) represent a communications fabric, which provides communications between various components of sub-system 102. This communications fabric can be implemented with any architecture designed for passing data and/or control information between processors (such as microprocessors, communications and network processors, etc.), system memory, peripheral devices, and any other hardware components within a system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for sub-system 102; and/or (ii) devices external to sub-system 102 may be able to provide memory for sub-system 102.

Program 300 is stored in persistent storage 210 for access and/or execution by one or more of the respective computer processors 204, usually through one or more memories of memory 208. Persistent storage 210: (i) is at least more persistent than a signal in transit; (ii) stores the program (including its soft logic and/or data) on a tangible medium (such as magnetic or optical domains); and (iii) is substantially less persistent than permanent storage. Alternatively, data storage may be more persistent and/or permanent than the type of storage provided by persistent storage 210.

Program 300 may include both machine-readable and performable instructions and/or substantive data (that is, the type of data stored in a database). In this particular embodiment, persistent storage 210 includes a magnetic hard disk drive. To name some possible variations, persistent storage 210 may include a solid-state hard drive, a semiconductor storage device, a read-only memory (ROM), an erasable programmable read-only memory (EPROM), a flash memory, or any other computer-readable storage media that is capable of storing program instructions or digital information.

The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202, in these examples, provides for communications with other data processing systems or devices external to sub-system 102, such as client sub-systems 104, 106, 108, 112 and deployment environment 110. In these examples, communications unit 202 includes one or more network interface cards. Communications unit 202 may provide communications through the use of either or both physical and wireless communications links. Any software modules discussed herein may be downloaded to a persistent storage device (such as persistent storage device 210) through a communications unit (such as communications unit 202).

I/O interface set 206 allows for input and output of data with other devices that may be connected locally in data communication with server computer 200. For example, I/O interface set 206 provides a connection to external device set 214. External device set 214 will typically include devices such as a keyboard, a keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. In these embodiments the relevant software may (or may not) be loaded, in whole or in part, onto persistent storage device 210 via I/O interface set 206. I/O interface set 206 also connects in data communication with display device 212.

Display device 212 provides a mechanism to display data to a user and may be, for example, a computer monitor or a smart phone display screen.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

### II. First Embodiment

Preliminary note: The flowchart and block diagrams in the following Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

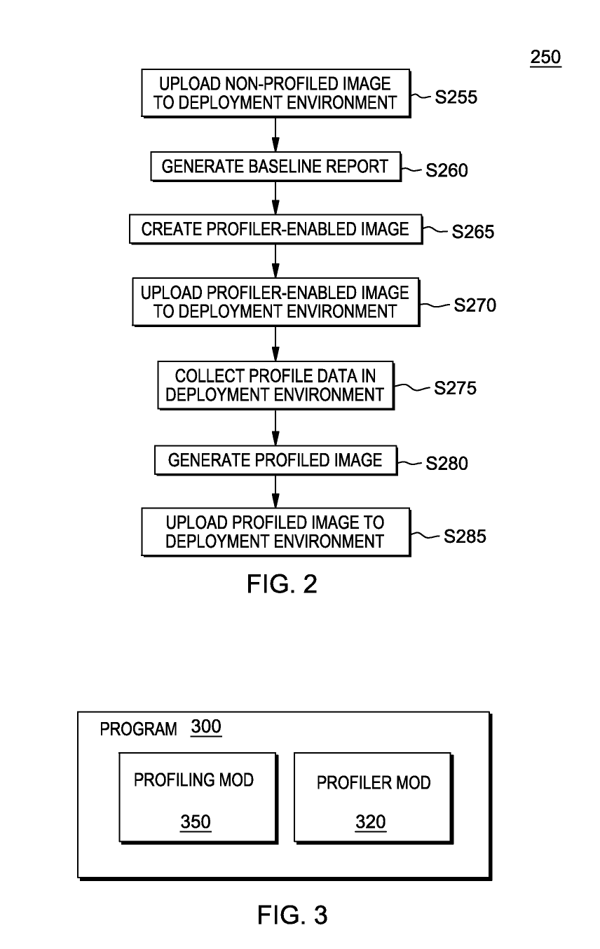

FIG. 2 shows flow chart 250 depicting a method according to the present invention. FIG. 3 shows program 300 for performing at least some of the method steps of flow chart 250. This method and associated software will now be discussed, over the course of the following paragraphs, with extensive reference to FIGS. 2 (for the method step blocks) and FIG. 3 (for the software blocks).

Processing begins at step S255, where baseline report module 310 receives a non-profiled software image to be optimized for the particular deployment environment where it resides (see definitions of “deployment environment” below, in the Definitions sub-section of this Detailed Description section). In this embodiment, there is only one deployment environment. Oftentimes, a single customer wishes to optimize a generic software image in more than one deployment environment. Where there are multiple deployment environments, each deployment environment receives a non-profiled software image to be optimized for that particular deployment environment. The non-profiled image is a generic software image having been developed for general use, that is, the software has been processed according to some conventional software development process including basic debugging practices, etc. For certain customers, the generic software image does not meet their processing requirements and/or performance expectations. Further, some customers require certain performance standards for each deployment environment within the customer's business.

Processing proceeds to step S260, where baseline report module 310 creates a baseline performance report within deployment environment 110 by running the software through a series of test sequences to determine performance parameters. Alternatively, the baseline performance report is created within the software developer's shop (one example of a non-deployment environment) and the baseline report module is located within server computer 200.

The baseline performance report contains performance statistics collected manually or with the aid of a software tool. The report contains baseline data used to evaluate the final profiled image. The baseline data consists of different metrics for comparing the initial performance of the software with the performance of the profiled software. The performance measurements consist of average measures for each business activity. The difference in the baseline and final report indicates the change in software performance.

Processing proceeds to step S265, where profiler module 320 creates the profiler-enabled software image. In this embodiment, the profiler-enable image is generated at the software developer's facility, where server sub-system 102 is operating. Alternatively, the profiler-enabled image is generated in deployment environment 110. In this alternative embodiment, the profiler module is located within the deployment environment. In this embodiment, the profiler is a software instrumentation feature that is activated to generate profile data for the environment in which it is running.

In this embodiment, the profiler-enabled software employs a code instrumentation type profiler. Alternatively, the profiler may be: (i) hardware interrupts; (ii) instruction set simulation; (iii) operating system hooks; and/or (iv) performance counters. The profile-enabled software image is created by: (i) instrumenting the program source code at compile time using the profiler; and (ii) providing a customer interface to access a profiler switch to activate the profiler so that the customer chooses when to collect the profile data via the profiler. Alternatively, in step (i) the binary executable form of the source code is instrumented at compile time. In this embodiment, the profiler uses an instrumented technique to obtain profile data. Alternatively, in step (ii) the software developer operates the profiler switch via remote access to activate the profiler of the instrumented version of the software image without visiting the customer's physical location.

The profiler-enabled software performs one, or more, of the following actions when it is active: (i) assigns different weights to each function being called; (ii) records individual function call counts; (iii) determines the possibility of transforming functions to inline functions; (iv) determines the possibility of instruction shuffling; (v) sort out different levels of optimizations that can be applied; and/or (vi) determines the possibility of instruction compression; and/or (vii) determines the possibility of different level of instruction compression.

In this embodiment, the profiler uses the instrumented technique to obtain profile data. Alternatively, the profiler uses any of the following techniques to obtain profile data: (i) event-based; (ii) statistical; (iii) simulation; (iv) utilization of processor optimization capabilities; (v) high order transformation (HOT) loop optimization; (vi) interprocedural analysis (IPA); (vii) profile directed feedback optimization (PDF); (viii) symmetric multiprocessing optimization (SMP); (ix) use of mathematics acceleration subsystem libraries; (x) use of user-directed source-level optimization; (xi) hand-coded optimized instructions; and/or (xii) optimization with respect to field programming gate arrays (FPGA).

Processing proceeds to step S270, where profiler-enabled image module 330 (see FIG. 1) of deployment environment 110 receives the profiler-enabled image created in step S265. In this embodiment, a single profiler-enabled image is uploaded to a single deployment environment because there is only one target deployment environment to be profiled within the customer's business. Alternatively, there are several deployment environments to be profiled within the customer's business and one profiler-enabled image is provided for each individual deployment environment.

Processing proceeds to step S275, where collect profile data module 340 (see FIG. 1) collects profile data from the profiler during operation of the software in the deployment environment, or target environment, for the software image. Profile data includes: (i) space, or memory, data of a program; (ii) time data of a program; (iii) usage data for particular instructions; (iv) frequency of function calls; (v) duration of function calls; and/or (vi) performance data.

Processing proceeds to step S280, where profiling module 350 receives collected profile data from profile data module 340 (see FIG. 1) to generate a profiled image, which is optimized by application of the collected profile data. In this embodiment, the profiled image is generated as part of a binary profiling process performed by the software developer on his computer system, referred to below as the binary profiling factory (one example of a non-deployment environment). Alternatively, the profiled image is generated in the deployment environment, so the collected profile data remains within the deployment environment. In this alternative embodiment, the profiling module is located in deployment environment 110 (see FIG. 1) instead of program 300.

Processing proceeds to step S285, where profiled image module 360 (see FIG. 1) receives the profiled image generated in step S280. In this embodiment, the single profiled image is loaded by the profiled image module for operation in the target environment of the customer's business. Alternatively, where there are multiple deployment environments, profiled image mod 360 distributes each of the profiled images to the corresponding deployment environment within the customer's business.

### III. Further Comments and/or Embodiments

Some embodiments of the present disclosure recognize that: (i) a significant challenge in binary profiling optimization is the process of picking the best training workload; (ii) selecting the training workload is very important; (iii) it is extremely difficult to have a unique training workload for generic software; (iv) generic software is used by many customers in different environments; and (v) using a single training workload is unlikely to be suitable for all environments.

Some embodiments of the present disclosure provide one, or more, of the following features, characteristics and/or advantages: (i) maximum throughput in a serendipitous manner for each environment; (ii) optimal performance of a given software product, including its stack, in each of the business environments in which the given software product is used (this is one example of a deployment environment) (see definitions of “deployment environment” below, in the Definitions sub-section of this Detailed Description section); (iii) use of binary profiling optimization (explained in more detail below) to achieve a high level of performance; (iv) delegating, from software developers to software customers at least some portions of the profiling process (for example, profile collection portion of the binary profiling optimization process); (v) use of special flags in order to gather run-time behavior; (vi) using the run-time behavior to generate improved binary code in subsequent compilations; (vii) running a “first special build,” which contains the instrumentation, with a training workload to create a profile database; and/or (viii) feeding the profile database into a subsequent compilation for higher order optimization.

In some embodiments, the process of subsequent compilation is performed after profile database generation rearranges the position of procedures in memory based on actual execution profiles. In some embodiments, this process of subsequent compilation does one or more of the following: (i) places the code of called procedures on the same page of memory as the calling routine based on hot code paths; (ii) rearranges branches and/or predicates not easily predictable control flow sequences; (iii) provides branch hints; (iv) performs help in pre-fetching; and/or (v) performs speculative loading of data for IPA-PDF implementations.

Some embodiments of the present disclosure apply the conventional steps of a usual binary profiling process, but revise the process by: (i) changing the conventional profiling environment; and/or (ii) including additional compilation steps.

Some embodiments of the present invention apply the profile collection portion of the profiling process at a real working environment (this is one example of a deployment environment), that is, where the software product is supposed to run. In other words, instead of following the typical profiling process of using training work loads, some embodiments of the present invention use the real business application environment, or business environment, to collect profile data while confined to only that business environment.

Some embodiments of the present invention use the collected business-centric profile data to perform a second level of compilation to create a binary profiling-based optimization of the software image. The resulting profiled image is a very highly optimized image for the specific business environment where the profile collection was performed. Finally, each fine-tuned image is deployed to its respective business environment.

Some embodiments of the present disclosure provide software customization according to each individual processing environment (one example of a deployment environment). For example, one process disclosed herein replaces a generic block of high level statements with a “double-distilled” assembly version of those statements that is optimized for the particular processing environment. In some embodiments of the present invention, the business environment is used as a profiling collection center that returns a custom profile database for each business unit, or other business division, to the binary profiling factory (or build center) (this is one example of a non-deployment environment). The build center then provides the customer with a profiled image that is optimized for each of the customer's networked environments. The customer's business environments are “real training buckets.”

Some embodiments of the present invention apply process steps including: (i) build the final image (A generic image) at the software production house (this is one example of a non-deployment environment); (ii) test and generate a report (report-1); (iii) ship and/or upload the generic image to each registered customer's business environment; (iv) deploy the generic images in the customer's sub-test environment for each customer business environment at each different sub-business unit (these are examples of deployment environments); (v) deploy the generic images in the customer's production environments; (vi) run the routine business using the generic images during profile collection; (vii) upload each profile database to the profile center of the software production house along with corresponding image information; (viii) perform binary profiling for each profile database and corresponding image information at the binary profiling house at the software production house; (ix) test and generate reports (report-2); (x) compare the reports from the generic image and the optimized, profiled image (report-1 and report-2); and/or (xi) determine if report-2 is better than report-1; (xii) where report-2 is better than report-1, ship the final profiled image to respective customer; (xiii) where report-2 is not better than report-1, which indicates performance degradation, fix the root cause manually by: (a) analyzing those functions with a higher hit ratio; and/or (b) optimizing the code if possible; (ivx) where there are code changes, build the new image and repeat the entire process described above; and/or (vx) where degradation occurs again, consider: (a) customizing some of the algorithms, and/or (b) re-writing the algorithms in a corresponding assembly language.

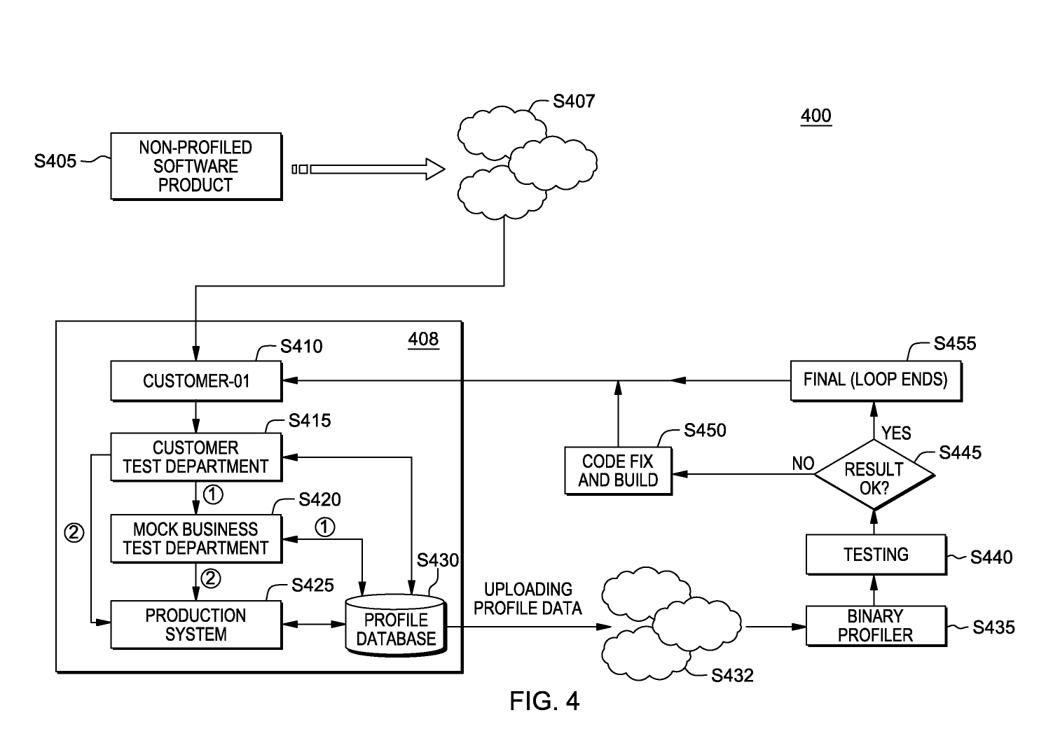

FIG. 4 illustrates a business-oriented profiling life cycle, processes 400, according to an embodiment of the present disclosure. The Figures depict business-oriented profiling for an individual production system, including operating stacks (this is one example of a deployment environment).

Process 400 begins with step S405, where non-profiled software product is uploaded to the software production house network (this is one example of a non-deployment environment). The software production house loads a profiler having on/off states onto software product.

Processing proceeds to step S407, where the non-profiled software product (NPSP), including a profiler in the “on” state, is tested and prepared for loading into memory within the customer's business environment, to initiate process 408. A baseline report is produced during this initial testing. In this embodiment, process 408 is performed entirely in the customer's business environment.

Process 408 begins at step S410, where the customer's business environment receives the NPSP, including a profiler in the “on” state, from the software production house.

Processing proceeds to step S415, where the customer test department chooses whether to: (i) test the NPSP according to business standards; or (ii) load the NPSP into the production system. If option (i) is chosen, the NPSP is run on the test machines, where a simulated environment is used for testing the software. Option (i) introduces an iterative process, where the software is tested and the results are evaluated prior to deciding whether to: (i) continue testing; or (ii) load the NPSP into the production system. In some cases, the test results are automatically approved upon testing, so that the NPSP is loaded into the customer's production system directly from step S420. Alternatively, the NPSP is loaded into the customer's production system from step S415 upon completion of testing.

If option (ii) is chosen at either step S415 or step S420, processing proceeds to step S425, where the NPSP is loaded into the production system in the customer's business environment.

Processing proceeds to step S430, where profile data collected by the profiler, which is turned on when the software is provided to the customer as a ‘non-profiled software product,” is stored in a profile database and process 408 ends. It should be noted that throughout steps S415, S420, and S425, the profiler may collect profile data that is stored in the profile database. The communication between customer nodes and the profile database is bi-directional. Initially, the profile database is empty, so initial profile information is collected and saved into the database. As new profiling records are inserted, or older profiling records are modified and/or updated.

Process 400a proceeds to step S432, where the profile data is uploaded to the software production house for processing.

Processing proceeds to step S435, where binary profiler applies profile data to the generic software product provided in step S405 to create a binary profiled image.

Processing proceeds to step S440, where the binary profiled image is tested in a manner similar to the testing in step S407. A profiled image report is produced.

Processing proceeds to step S445, where the baseline report is compared to the profiled image report. If the baseline report indicates poorer performance than the binary profiled image report, processing proceeds to step S455, where the binary profiled image is supplied to the customer as a final optimized product to be uploaded for general availability on the customer's network. Alternatively, the binary profiled image is processed to collect profile data one or more cycles before releasing the optimized software to the customer.

If the baseline report indicates better performance than the profiled image report, processing proceeds to step S450, where the program code is modified and the revised software product is built for next profiling process 408 in the customer's business environment. Steps S410 through S445 define an iterative process that is repeated as described above, resulting in a next profiled image report. At step S445, the baseline report and the next profiled image report are compared. The actions described above in response to a positive or negative result apply again at step S445.

### IV. Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as maybe being new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

User/subscriber: includes, but is not necessarily limited to, the following: (i) a single individual human; (ii) an artificial intelligence entity with sufficient intelligence to act as a user or subscriber; and/or (iii) a group of related users or subscribers.

Electrically Connected: means either directly electrically connected, or indirectly electrically connected, such that intervening elements are present; in an indirect electrical connection, the intervening elements may include inductors and/or transformers.

Data communication: any sort of data communication scheme now known or to be developed in the future, including wireless communication, wired communication and communication routes that have wireless and wired portions; data communication is not necessarily limited to: (i) direct data communication; (ii) indirect data communication; and/or (iii) data communication where the format, packetization status, medium, encryption status and/or protocol remains constant over the entire course of the data communication.

Receive/provide/send/input/output: unless otherwise explicitly specified, these words should not be taken to imply: (i) any particular degree of directness with respect to the relationship between their objects and subjects; and/or (ii) absence of intermediate components, actions and/or things interposed between their objects and subjects.

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Software storage device: any device (or set of devices) capable of storing computer code in a manner less transient than a signal in transit.

Tangible-medium software storage device: any software storage device (see Definition, above) that stores the computer code in and/or on a tangible medium.

Non-transitory software storage device: any software storage device (see Definition, above) that stores the computer code in a non-transitory manner.

Computer: any device with significant data processing and/or machine-readable instruction reading capabilities including, but not limited to: desktop computers, mainframe computers, laptop computers, field-programmable gate array (fpga) based devices, smart phones, personal digital assistants (PDAs), body-mounted or inserted computers, embedded device style computers, application-specific integrated circuit (ASIC) based devices.

Deployment environment: any real world business environment for running computer software in which a customer (of a software developer) does actual, real world business using the software; for example, a server computer owned and deployed by the customer's IT staff, which servers business associates of the customer (or customers of the customer) over the Internet would be an example of a “customer's networked computers environment”; on the other hand, if a customer brings his laptop computer to a motel conference room to meet the software developer then that would not be an example of a “customer's networked computers environment” (unless that is normally how the customer communicates with its own customers); a single customer may have more than one “customer's networked computers environment”; for example, a bank with a branch in China and a branch in India would be considered to have two “customer's networked computers environments”; a “customer's networked computers environment” will generally have many, many variables associated with it, such as hardware, middleware, embedded software, device drivers, OSs (operating system) & OS packages, common libraries, virtual machines, interpreters, hyperwares, application servers, workload managers, software hosting environment, transaction servers, messaging system, database servers, data scanners/parsers, customer applications, security servers, data sets, security software, geographic location, atmospheric conditions, computer operator morale, physical facilities, physical tools, equipment (for example, office equipment), computing resources, communications systems, techniques, standards, workspace, laboratories, procedures, janitorial practices, as wired communication lines serving the environment (both the type of lines and the actual physical condition and layout of the lines), the wireless service in the environment, the average amount of data traffic the environment experiences, the distribution over time of the data traffic the environment experiences, the weather, the carefulness of the customers employees who work with the software and/or the equipment upon which the software is run, the processor speeds of the customer computers, processor types of the customer computers, network addressing space, lighting, lightning strikes, seismic activity, local voltage variations, and so on.

Actual business operations: any real world business-related work that a piece of software is designed to do in normal operation.

1. A method comprising:
setting up an instrumented version of a first software image to run in a customer business environment;
generating profile data by running the instrumented version of the first software image in a test deployment environment within the customer business environment to perform actual business operations; and
performing binary profiling on the first software image, based, at least in part, upon the profile data, to create a second software image that is fine tuned for a production system within the customer business environment.

2. The method of claim 1 further comprising:
activating, in the test deployment environment, a software instrumentation feature of the instrumented version of the first software image that enables generation of the profile data when the instrumented version of the first software image is run in the test deployment environment;
wherein activation occurs in one of the following two ways: (i) through a user interface, included in the first software, that is accessible in the test deployment environment, or (ii) by remote activation performed over a communication network.

3. The method of claim 1 further comprising:
reporting a first performance data for the instrumented version of the first software image;
reporting a second performance data for the second software image; and
comparing the first performance data to the second performance data.

4. The method of claim 3 further comprising:
responsive to the second performance data indicating improved performance over the first performance data, running the second software image in the production system.

5. The method of claim 3 wherein the first performance data is collected in the test deployment environment.

6. The method of claim 1 wherein the performing binary profiling step occurs in a software developer's computer system.

7. The method of claim 1 wherein the test deployment environment and the production system are on the same device.

8. The method of claim 1 wherein the test deployment environment and the production system are on different devices.

9. The method of claim 1 wherein the test deployment environment spans a set of test machines.

10. The method of claim 1 wherein the customer business environment comprises a single device.
